(19) United States
(12) Patent Application Publication
(10) Pub. No.: US 2026/0022049 A1
(43) Pub. Date: Jan. 22, 2026

(54) GLASS MELTING FURNACE WITH SUBMERGED BURNER, COMPRISING AN ANTI-SLOSH BARRIER

(71) Applicant: SAINT-GOBAIN ISOVER, COURBEVOIE (FR)

(72) Inventors: William WOELFFEL, AUBERVILLIERS (FR); Antoine GUILLET, COURBEVOIE (FR)

(21) Appl. No.: 18/875,500

(22) PCT Filed: Jun. 15, 2023
(86) PCT No.: PCT/EP2023/066190

§ 371 Date: Dec. 16, 2024

(30) Foreign Application Priority Data
Jun. 17, 2022 (FR) 2205973

(51) Int. Cl. C03B 5/42; C03B 5/235; F27D 9/00

(52) U.S. Cl. CPC C03B 5/42; C03B 5/2356; F27D 9/00; C03B 2211/22; F27D 2009/0013; F27M 2001/07

(57) ABSTRACT

A facility for melting a composition of raw materials suitable for obtaining glass wool, rock wool, textile glass fibers and/or flat glass or hollow glassware, the facility including a melting chamber provided with at least one inlet, at least one outlet and at least one submerged burner proximal to the outlet. The facility includes a barrier arranged between the proximal burner and the outlet, which barrier is intended to limit the sloshing movement of the glass, in particular at the surface of the bath.

The present invention relates to a facility for melting a composition of raw materials suitable for obtaining glass and/or rock fibers, of the mineral wool type for thermal or acoustic insulation, “reinforcing” textile glass fibers and/or flat glass.

In the present text, these “raw materials” first comprise vitrifiable materials which make it possible to obtain the targeted mineral composition of the glass or rock or silicate type. These vitrifiable materials comprise silica sand, but also all the additives (sodium carbonate, limestone, dolomite, aluminum, etc.), and any type of cullet. In the description, the terms “liquid glass” and “glass bath” refer to the product of the melting of these vitrifiable materials. The raw material compositions also include recyclable materials containing (organic) fuel elements, for instance waste from sized mineral fibers, with binder (of the type used in thermal or acoustic insulation or used in the reinforcement of plastic material), originating from the production plants (factories) of said fibers, work sites (construction or deconstruction) and/or recycling streams that make it possible to recover such fibers from end products, whether or not they are spent end products. Such mineral fibers may in particular consist of glass and/or rock. They are then known as glass wool and rock wool, respectively. Also included are laminated glazings with sheets of polymer of the polyvinyl butyral type such as windshields, glass bottles (household cullet), or any type of “composite” material that combines glass and plastic materials such as certain bottles. Also recyclable are “glass-metal composites or metal compounds” such as glazings coated with enamel layers, metal layers and/or different connection elements. Also included in the raw materials are all the biomass forms, that is organic matter of plant, animal, bacterial or fungal origin, which can be used mainly as fuel, but also acting as a raw material influencing the composition of the vitrifiable material manufactured since its ash content is generally not zero.

The invention relates more particularly to a so-called “submerged-burner” facility (furnace). Such burners are generally fed with a mixture of oxygen and gas, or a mixture of air and gas, and are generally arranged so that they are flush with the bottom of the melting chamber, so that the flame develops within the mass of raw materials being liquefied. These burners can be such that their gas supply lines are flush with the wall through which they pass. According to some embodiments, it is also possible to choose to inject only the gases resulting from combustion, the combustion being carried out outside the melting chamber itself.

As is known, the bottom part of a melting chamber of such a facility comprises a raw material intake or submerged inlet located below the theoretical level of the molten raw material bath, also referred to as the glass bath throughout this description. The raw materials are generally fed into the melting chamber by means of a feeder comprising a body with a sheath and a mechanical system for conveying the raw materials, in the form of a piston or worm screw. Thereafter, the molten mixture leaves the furnace via a dedicated outlet for a subsequent step of fiberizing glass wool or spinning glass textile fibers. The furnace inlet(s) and outlet(s) are adapted to allow the introduction of raw materials on the one hand and simultaneously the extraction of molten material on the other, such that, throughout the melting process, the level of the glass bath remains substantially constant. The amount of molten material at the furnace outlet, per unit time (for example, in tons per day) is referred to as the load.

One disadvantage of the known technology is the variations observed by the inventors of this load, over relatively short periods of time. Such variations in output rate, also referred to as instabilities in the following text, are detrimental to the quality of the products obtained after forming. Indeed, instantaneous variations in glass load lead to instability in the fiberization, thereby generating more waste. Another disadvantage is that the amount of fibers created at a given moment also varies, which is detrimental to controlling the density of the product obtained. However, this is an essential feature for evaluating the quality of the products obtained.

The invention is intended to provide a technical solution to the disadvantages described hereinbefore. More particularly, in at least one embodiment, the proposed technique relates to a facility for melting a composition of raw materials suitable for obtaining glass wool, rock wool, textile glass fibers and/or flat glass or hollow glassware, the facility comprising a melting chamber provided with at least one inlet, at least one outlet and at least one submerged burner proximal to said outlet, characterized in that said facility comprises an “anti-slosh” barrier arranged between said proximal burner and said furnace outlet, at a horizontal distance (dX) from said proximal burner of between 20% and 80% of the total horizontal distance (dTot) separating said proximal burner from said outlet, preferentially between 30% and 70%, more preferentially between 40% and 60%, even more preferentially between 45% and 55% of the total horizontal distance separating said proximal burner from said outlet.

Throughout the text, the expression “horizontal distance” refers to a distance measured in a horizontal plane between the orthogonal projections (on this horizontal plane) of each of the designated elements. Thus, the distance separating a furnace outlet from the proximal burner thereof, that is the burner closest thereto, also referred to as the “last burner” in this text, is measured.

The invention is based on a novel and inventive concept involving the use of an anti-slosh barrier at a selected distance between the “last” burner and the furnace outlet. “Barrier” means a device in the form of an obstacle or set of obstacles to the local flow of the glass bath, thereby making it possible to reduce sloshing without necessarily eliminating it.

In this context, it should be noted that, although problems of furnace load instability may have been observed in the past, it was impossible to observe what was happening inside a furnace in real time. In order to better understand the causes of this instability, and as described in detail in the description, the inventors thus established and conducted a comprehensive research program aimed at reproducing, in the laboratory, the hydrodynamic phenomena present within an industrial furnace, so as to be able to identify and better understand them. This research program particularly brought to light a phenomenon referred to as “sloshing”, generated within the glass bath, and made it possible to observe the advantageous reduction in this sloshing caused by the use of an “anti-slosh” barrier according to the invention. The term “sloshing” (and by extension “anti-slosh” to describe the barrier according to the invention) has been chosen because of the phenomenon generated within the glass bath and more particularly illustrated by the figures of the experimental facility with said barrier which will be described subsequently. By definition, the term “sloshing” denotes the movement of a body that sloshes, i.e. that moves alternately in one direction and in the other (Dictionnaire de la langue française, Le Petit Robert).

In particular, the inventors were able to observe that the reduction in sloshing is better when said barrier is arranged at mid-distance (i.e. dX=50% dTot) between the last burner and the outlet, and tends to decrease as the barrier moves away from this mid position. In particular, an arrangement at less than 20% of the horizontal distance separating this last burner from said outlet is considered to be unacceptable, firstly because it promotes the generation of a strong current loop within the glass bath-which reduces the residence time of the glass in the furnace and increases the risks of unmelted material—and secondly because such an arrangement close to the burner generates an increase in the phenomena of heat loss and corrosion at the barrier. Conversely, positioning the anti-slosh barrier close to the furnace outlet could result in the undesired formation of a glass plug, particularly when the barrier is cooled from outside the furnace.

According to a particular embodiment, the anti-slosh barrier is arranged in the vicinity of the surface of the glass bath in order to form an obstacle which is able to at least limit the phenomenon referred to as sloshing.

Advantageously, the anti-slosh barrier is configured to limit, or even cancel out, said sloshing phenomenon occurring in the glass bath, particularly but not exclusively on the surface of said bath.

According to a particular embodiment, said anti-slosh barrier is configured to leave an atmospheric connection between upstream and downstream of said barrier. By virtue of this connection, the atmospheric pressure upstream and downstream of the anti-slosh barrier is the same.

Advantageously, the anti-slosh barrier according to the invention is arranged on the surface of the glass bath in order to form an obstacle, in particular to the currents present on the surface of said bath in order to stabilize the surface thereof. The anti-slosh barrier is preferably partially submerged in the glass bath.

According to a particular embodiment, said anti-slosh barrier comprises a first part which is arranged vertically so as to be flush below the theoretical level of the glass bath.

According to a particular embodiment wherein the liquid glass leaves the furnace by overflow, this theoretical level of the glass bath corresponds to the height of the furnace outlet, and more precisely is defined by the theoretical horizontal plane passing through this outlet. As described in detail in the description, experimental tests carried out by the inventors demonstrated that an anti-slosh barrier positioned in this way was more effective.

According to a particular embodiment, said anti-slosh barrier comprises a second part which is arranged vertically so as to be flush above the theoretical level of the glass bath.

Given the relatively high viscosity of the glass bath, and as described in detail in the description, experimental tests carried out by the inventors demonstrated that the use of an anti-slosh barrier, at least one component of which is flush above the surface of the glass bath, in addition to another part which is flush below, makes it possible to limit the surface overflow of said glass bath, and therefore the sloshing phenomenon.

According to a particular embodiment, said anti-slosh barrier is arranged vertically above a height equal to 60% of the height of the theoretical level of the glass bath, preferentially 70%, more preferentially 80% of the height of the theoretical level of the glass bath.

According to a particular embodiment, said first part of the anti-slosh barrier comprises a first rectilinear element which extends across the width of the melting chamber.

According to a particular embodiment, said second part of the anti-slosh barrier comprises a second rectilinear element arranged above said first rectilinear element in a direction parallel to the latter.

In other words, the anti-slosh barrier is arranged so that the theoretical horizontal mid plane between the two rectilinear elements substantially coincides with the theoretical level of the glass bath. In this configuration, the first rectilinear element is thus fully submerged, whereas the second rectilinear element is arranged above the glass bath, acting as a barrier to any surface waves.

According to a particular embodiment, the first rectilinear element and the second rectilinear element are spaced apart from one another by a distance of between 0.1 and 16 mm, preferentially between 2 and 12 mm, preferentially between 4 and 8 mm.

In practice, devitrified material (crystallized glass) is formed locally as a result of the cooling of the liquid glass at its interface with the anti-slosh barrier. The space between the two rectilinear elements forming this barrier is thus clogged up with this devitrified material, which contributes to forming an obstacle to the flow of the glass bath, while reducing the contact surface of the rectilinear elements with the glass bath, thereby making it possible to reduce the associated heat loss. Although the thickness of the devitrified material formed may vary depending on several parameters (nature of the glass bath, dimensions of the barrier, etc.) that a person skilled in the art is able to control, the preferential ranges of values claimed for this spacing between the rectilinear elements offer an optimum compromise between the formation of an effective obstacle to the flow of the glass bath and the limiting of heat loss.

According to a particular embodiment, said first rectilinear element and/or said second rectilinear element has a tubular section.

The advantage of using a tubular section is that the stresses generated by the glass bath are satisfactorily distributed over the rectilinear element in question.

According to a particular embodiment, said first rectilinear element and/or said second rectilinear element has a rectangular section.

The advantage of using a rectangular section is giving the rectilinear element better resistance to hot creep, in particular when the rectilinear element is very long.

According to a particular embodiment, said anti-slosh barrier has a depth to height ratio of less than 70%, preferentially less than 50%, preferentially less than 30%.

The inventors have thus observed that the anti-slosh effect of the barrier increases as the ratio of the depth to the height thereof decreases.

According to a particular embodiment, the ratio of the height of said anti-slosh barrier to the height of the glass bath is between 10% and 60%, preferentially between 25% and 45%.

When this ratio of the height of the barrier to the height of the glass bath is less than 10%, the anti-slosh effect is significantly reduced. Conversely, when this ratio is greater than 60%, heat loss at the barrier tends to be too high. The best compromise between these two aims is achieved when the ratio of heights is between 25% and 45%.

According to a particular embodiment, said anti-slosh barrier consists of bare metal walls which are traversed by a system of internal pipes for cooling by fluid, preferentially water.

The invention also relates to a process for manufacturing glass wool, rock wool, glass textile fibers and/or flat glass or hollow glassware, characterized in that said manufacturing process implements at least one step of melting a composition of raw materials in such a facility.

The density of the mineral wool produced varies with the furnace load. Thus, the more stable this load is, the more homogeneous the density of the product obtained will be. A mineral wool such as that obtained via the manufacturing process described above therefore has a relatively low standard deviation regarding the density thereof, which limits the risks of obtaining a product that is lighter and less insulating than desired, or on the contrary more insulating but too heavy for the building it is intended to equip.

Further features and advantages of the invention will become apparent from the following description of particular embodiments, given merely as illustrative and non-limiting examples, and the appended figures, for which:

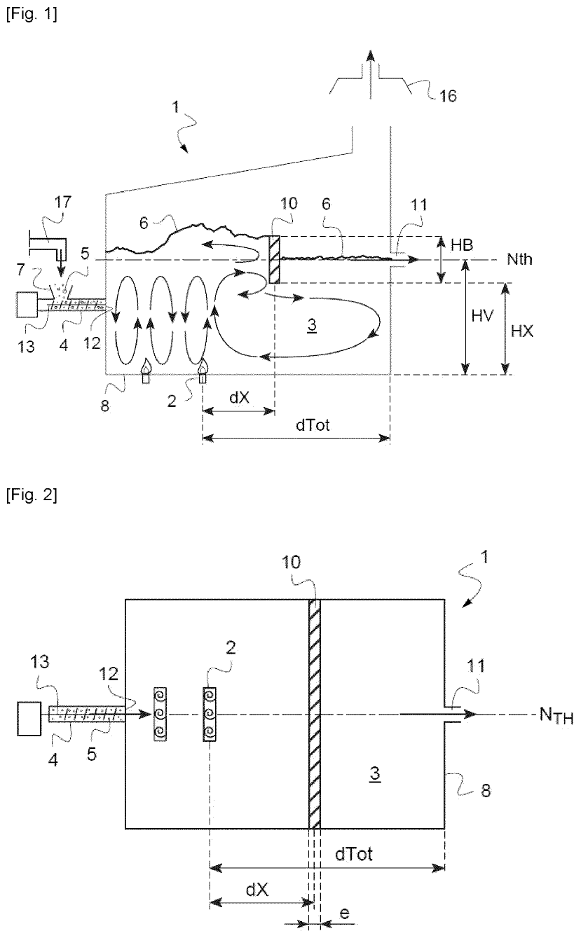

FIG. 1 is a schematic side view of a facility for melting a composition of raw materials, according to a particular embodiment of the invention,

FIG. 2 is a schematic plan view of a facility for melting a composition of raw materials, according to a particular embodiment of the invention,

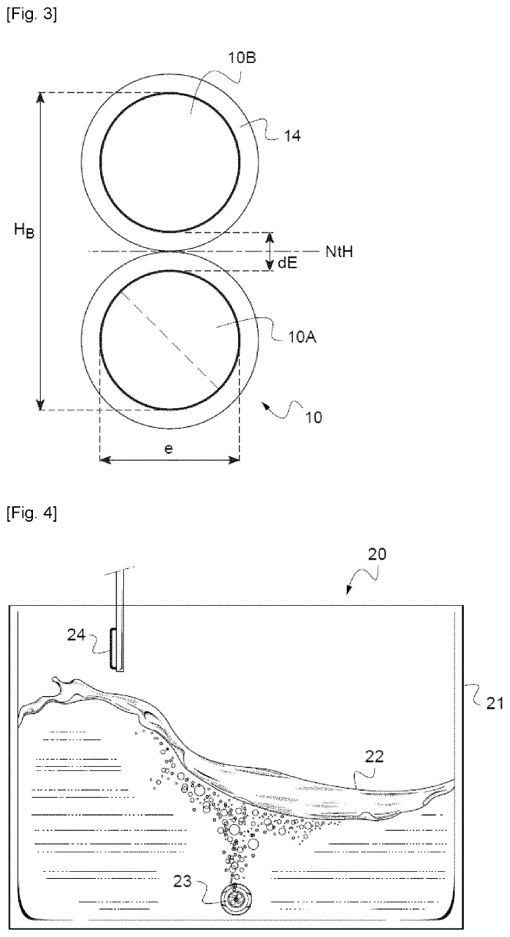

FIG. 3 is a schematic side view of an anti-slosh barrier of a facility according to a particular embodiment of the invention,

FIG. 4 is a schematic side view of an experimental facility implemented by the inventors, with a barrier in non-operational configuration,

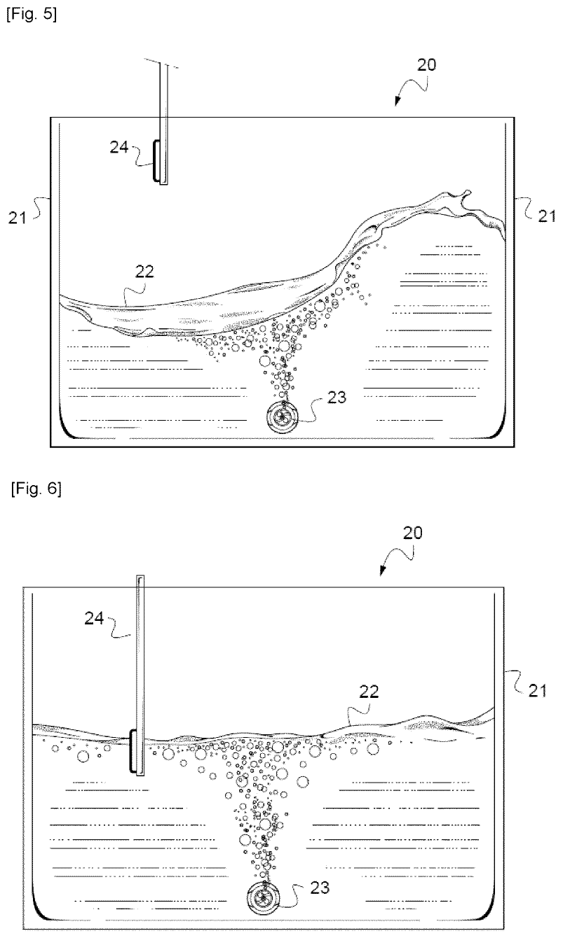

FIG. 5 is a schematic side view of the experimental facility illustrated in FIG. 4, with a barrier in non-operational configuration, depicting a later instant.

FIG. 6 is a schematic side view of an experimental facility illustrated in FIGS. 4 and 5, with a barrier in the operational configuration.

The various elements illustrated in the figures are not necessarily shown to actual scale, the emphasis being more on representing the general operation of the invention. In the various figures, unless otherwise indicated, reference numbers that are identical represent similar or identical elements.

Several particular embodiments of the invention are presented below. It is understood that the present invention is in no way limited by these particular embodiments, and that other embodiments are perfectly possible.

FIGS. 1 and 2 schematically depict a furnace (facility 1) with submerged burners according to a particular embodiment of the invention, seen from the side (FIG. 1) and from above (FIG. 2), respectively. Such a furnace 1 comprises two burners, including one burner proximal to the furnace outlet-referenced 2—which is the burner closest to the furnace outlet. These burners are submerged in a bath 3 of vitrifiable materials being melted, at a temperature generally of between 1200° C. and 1700° C. A worm screw 13 pushes a composition 5 of raw materials under the surface 6 of the material being melted in the furnace. A dispenser 17 meters and supplies the preformed mixture to a feed hopper 7, which then supplies the endless screw 13 rotating in a casing 4. The preformed mixture is introduced into the furnace via the orifice 12, also called the point of feeding. The inside of the furnace 1 comprises at least one chamber 8 containing the bath 3 of melting vitrifiable material. The formed mineral material exits via the outlet 11 below the level of the molten materials. The combustion gases escape via a chimney 16.

A facility 1 according to the invention comprises in particular an anti-slosh barrier 10 arranged at the surface of the glass bath 3, in order to limit the effects of sloshing caused at the furnace outlet 11.

For the purposes of spatial location, FIGS. 1 and/or 2 illustrate in particular:
the theoretical level (Nth) of the glass bath 3, which corresponds to the height (Hv) of the outlet 11,
the height (Hx) of the lower end of the barrier 10,
the height (Hb) of the barrier 10,
the total horizontal distance (dTot) separating the proximal burner 2 from the outlet 11,
the horizontal distance (dX) separating the proximal burner 2 from the barrier 10.

According to the particular, non-limiting, embodiment illustrated in FIGS. 1 and 2, such a barrier 10 is formed by a single rectilinear block which has a rectangular section and extends across the width of the furnace 1. Preferably, the barrier 10 extends across the entire width of the chamber 8 of the furnace 1. Such a barrier is arranged, between the proximal burner 2 and the furnace outlet 11, at a horizontal distance (dX) from the proximal burner 2 equal to 40% of the total distance (dTot) separating said proximal burner 2 from the outlet 11, and positioned at a height (Hx) greater than 80% of the height (Hv) of the glass bath 3, the height of the barrier (HB) being otherwise equal to 35% of the height (Hv) of the glass bath.

The glass bath 3 is moved by convection currents generated within it by the burners, the shape of which depends directly on the geometry of the various furnace elements in contact with the glass, as well as on the positioning of these burners 2. For illustrative purposes, some of these convection currents are depicted in FIGS. 1 to 3 by dedicated arrows. The specific arrangement of the barrier 10 in the furnace makes it possible in particular to form an obstacle to the currents present on the surface of the glass bath, so as to deflect said currents or at least reduce the intensity thereof, thereby stabilizing the surface of the glass bath at the furnace outlet 11.

FIG. 3 is a schematic side view of an anti-slosh barrier 10 of a facility 1 according to a particular embodiment of the invention wherein said barrier is formed of two rectilinear tubular elements 10A, 10B, which are arranged vertically on either side of the theoretical surface of the glass bath (Nth) or, in other words, flush with the latter. Each of these tubular elements 10A, 10B consists of bare metal walls cooled by an internal system of water pipes, also referred to as a water jacket. Following cooling of the liquid glass at its interface with each of these tubular elements 10A, 10B, a layer of devitrified material 14 (crystallized glass) is formed to completely cover the barrier 10, in particular filling the space (dE) located between the two tubular elements 10A, 10B, 6 cm long in this example. According to this particular embodiment, the height (Hb) of the barrier 10 corresponds to the distance separating the lower end of the first tubular element 10A (submerged) from the upper end of the second tubular element 10B (not submerged). The depth (e) of the barrier 10 corresponds to the diameter of these tubular elements. In the present case, the ratio of the depth (e) of the barrier 10 to the height (Hb) thereof is less than 50%.

As part of a research program aimed at gaining a better understanding of the causes of instabilities generated within a submerged-burner furnace, several experimental protocols were developed by the inventors in order to reproduce, in the laboratory, the hydrodynamic phenomena present within an industrial furnace. FIGS. 4 to 6 are schematic side views of a first experimental model 20 developed for these research purposes, which comprises a chamber 21 containing water 22 which is intended to reproduce the behavior of the glass bath. A bubbler 23 is centered at the bottom of chamber 21, so as to reproduce, in the water 22, the entrainment effect caused by the burners submerged in the glass bath. A barrier 24 formed by a single rectangular block having a substantially flat shape is arranged across the width of the chamber, and is movable between a “non-operational” position wherein this barrier 21 is positioned well above the water bath 22 (FIGS. 4 and 5), and an “operational” position wherein this barrier 21 is submerged in the water 22, so that the upper end thereof is level with the surface of the bath 22 at rest (FIG. 6).

In the context of this first experimental model, a 5 cm-high barrier is initially placed in the “non-operational” position, while the water level is set at 15 cm. Air is injected via the bubbler 23 at a flow rate of 7 Nm3/h (Normal cubic meter per hour). The sloshing behavior of the water is then captured by a video camera. FIGS. 4 and 5 are schematic depictions of screenshots from the video recording. In particular, the left-to-right movement of the jet of bubbles can be seen, reflecting the sloshing generated at the surface. Secondly, the barrier 24 is arranged in the “operational” position, with the other parameters remaining the same. FIG. 6 is a schematic depiction of a screenshot from the video recording taken immediately after the barrier 24 was submerged. Stabilization of the jet of bubbles in the center of the chamber 21, and a canceling-out of the sloshing effect, can be observed in this figure.

The experiment is then repeated, varying the height (Hb) of the barrier 24, the air injection rate, and the water level. The results observed are compiled in Table 1 below:

TABLE 1
Variation in amplitude of surface waves after submerging the barrier,
based on the water level, barrier height and injected air flow rate.

| | Height (Hb) of barrier | | | | |
|---|---|---|---|---|---|
| | Hb = 5 cm | | | Hb = 10 cm | |
| Level | Air flow rate | | | | |
| (cm) | 7.3 Nm3/h | 12 Nm3/h | | 7.3 Nm3/h | 12 Nm3/h |
| 15 | Canceled out | 25-50 | mm | Canceled out | Canceled out |
| 30 | Canceled out | Canceled out | | Canceled out | Canceled out |
| 35 | Canceled out | 50-90 | mm | Canceled out | 40 mm |
| 40 | Canceled out | 60-120 | mm | Canceled out | Canceled out |

This first experimental model and the results obtained and presented in Table 1 highlight the effectiveness of the anti-slosh barrier 21 under all the experimental conditions tested. Thus, either sloshing is canceled out, or the amplitude of the waves is acceptable, since it corresponds to that of a surface agitated by strong bubbling without sloshing.

In the context of a second experimental model, liquid water is replaced by a silicone oil having a viscosity of 500 centistokes (cSt), in order to better account for the high viscosity of a glass bath. At the same time, the barrier 21 is replaced by two 25 cm-diameter rectilinear tubes arranged one above the other and on either side of the level of the silicone oil bath at rest, according to a configuration identical to that shown in FIG. 3. Similarly to the first experimental model, the change in behavior of the silicone oil bath after the barrier is submerged is recorded using a video camera. When the barrier is in the non-operational position, significant sloshing can be clearly observed on the surface of the oil bath. Switching the barrier to the “operational” configuration puts an end to the sloshing effect, under all the experimental conditions tested, as detailed in Table 2 below.

TABLE 2
Observation (or lack thereof) of sloshing on the basis of barrier
configuration, silicone oil level and air flow rate.

| | | |
|---|---|---|
| Level | Air flow rate | Sloshing? |

| (cm) | (Nm3/h) | Without barrier | With barrier |
|---|---|---|---|
| 15 | 7.3 | Yes | No |
| | 12.7 | No | No |
| | 20 | Yes | No |
| 30 | 7.3 | Yes | No |
| | 12.7 | Yes | No |
| | 20 | Yes | No |
| 35 | 7.3 | No | No |
| | 12.7 | Yes | No |
| | 20 | Yes | No |
| 40 | 7.3 | No | No |
| | 12.7 | Yes | No |
| | 20 | Yes | No |

This second experimental model and the results obtained and presented in Table 2 highlight the effectiveness of the anti-slosh barrier 21 under all the experimental conditions tested, with sloshing being canceled out every time following the barrier being submerged.

1. A facility for melting a composition of raw materials suitable for obtaining glass wool, rock wool, textile glass fibers and/or flat glass or hollow glassware, the facility comprising a melting chamber provided with at least one inlet, at least one outlet and at least one submerged burner proximal to said at least one outlet, and an anti-slosh barrier arranged between said at least one submerged burner and said at least one outlet, at a horizontal distance from said proximal at least one submerged burner of between 20% and 80% of a total horizontal distance separating said at least one submerged burner from said at least one outlet of a total horizontal distance separating said at least one submerged burner from said at least one outlet.

2. The facility according to claim 1, wherein said anti-slosh barrier comprises a first part which is arranged vertically so as to be flush below a theoretical level of a glass bath.

3. The facility according to claim 2, wherein said anti-slosh barrier comprises a second part which is arranged vertically so as to be flush above the theoretical level of a glass bath.

4. The facility according to claim 1, wherein said anti-slosh barrier is arranged vertically above a height equal to 60% of a height of the theoretical level of a glass bath.

5. The facility according to claim 2, wherein said first part of the anti-slosh barrier comprises a first rectilinear element which extends across the width of the melting chamber.

6. The facility according to claim 5, wherein said second part of the anti-slosh barrier comprises a second rectilinear element arranged above said first rectilinear element in a direction parallel to the latter.

7. The facility according to claim 6, wherein the first rectilinear element and the second rectilinear element are spaced apart from one another by a distance of between 0.1 and 16 mm.

8. The facility according to claim 5, wherein said first rectilinear element and/or said second rectilinear element has a tubular section.

9. The facility according to claim 5, wherein said first rectilinear element and/or said second rectilinear element has a rectangular section.

10. The facility according to claim 1, wherein said anti-slosh barrier has a depth to height ratio of less than 70%.

11. The facility according to claim 1, wherein a ratio of a height of said anti-slosh barrier to a height of the glass bath is between 10% and 60%.

12. The facility according to claim 1, wherein said anti-slosh barrier consists of bare metal walls which are traversed by a system of internal pipes for cooling by fluid.

13. The facility according to claim 1, wherein said anti-slosh barrier is arranged in the vicinity of a surface of the glass bath in order to form an obstacle which is able to at least limit or cancel out sloshing.

14. The facility according to claim 1, wherein said anti-slosh barrier is configured to leave an atmospheric connection between upstream and downstream of said barrier.

15. A process for manufacturing glass wool, rock wool, glass textile fibers and/or flat glass or hollow glassware, the process comprising melting a composition of raw materials in a facility according to claim 1.

16. The facility according to claim 1, wherein the anti-slosh barrier is arranged at a horizontal distance from said at least one submerged burner of between 30% and 70% of the total horizontal distance separating said at least one submerged burner from said at least one outlet.

17. The facility according to claim 4, wherein the anti-slosh barrier is arranged vertically above the height equal to 70% of the height of the theoretical level of the glass bath.

18. The facility according to claim 7, wherein the first rectilinear element and the second rectilinear element are spaced apart from one another by the distance of between 2 and 12 mm.

19. The facility according to claim 10, wherein said anti-slosh barrier has a depth to height ratio of less than 50%.

20. The facility according to claim 11, wherein said ratio of a height of said anti-slosh barrier to a height of the glass bath is between 25% and 45%.
